(19) United States
(12) Patent Application Publication
(10) Pub. No.: US 2003/0083032 A1
(43) Pub. Date: May 1, 2003

(54) Apparatus and method for noise reduction

(76) Inventor: Inaki Eizmendi, Blibao (ES)

Correspondence Address: MINTZ LEVIN COHN FERRIS GLOVSKY AND POPEO PC, 12010 SUNSET HILL ROAD, SUITE 900, RESTON, VA, 20190, US

(21) Appl. No.: 09/839,782

(22) Filed: Apr. 20, 2001

(51) Int. Cl. H04B 1/10

(52) U.S. Cl. 455/296

(57) ABSTRACT

A method and apparatus for noise cancellation in a communication device is disclosed. The method utilizes power supplied from a battery to a buzzer circuit and a plurality of analog impedance elements to generate an audible output which is applied to the circuit to cancel noise. The noise results from a non-constant driving current. The acoustic output is opposite but equal in magnitude to the noise. In an alternative, an algorithm may be programmed into a power management application specific integrated circuit (ASIC) to cancel the noise.

### FIELD OF THE INVENTION

This invention relates to noise reduction and more particularly, to an apparatus and method for reducing noise in cellular telephones.

### BACKGROUND OF THE INVENTION

In communications, noise is an undesirable element. Noise hampers accurate reception of transmitted information. There are several sources that cause this noise. In a communication system such as a GSM system as illustrated in FIG. 1, for example, TDMA noise results from a discontinuous transmission of the radio frequency (RF) signal. The discontinuous nature of the signal manifests itself as a pulsed transmission. The pulsed transmission causes a pulsed current consumption in the power amplifier (PA) of a communication device. The pulsed current consumption produces a magnetic field of sufficient magnitude to generate an audible sound in some devices.

In general, a sound generator (such as a buzzer or ringer) in a cellular communication device (such as a mobile phone) similar to buzzer 200 illustrated in FIG. 2, consists of an inductor 210 which, when current I is driven through, creates a magnetic field. The magnetic field moves a magnetic material that impacts a plate-like element to generate an audible sound. The buzzer or ringer is designed to generate a sound when AC current flows through. This sound from the buzzer or ringer may be used to indicate an incoming call for example.

The sound level in buzzer 200 may be defined by:

Sound_{buzzer}=K₁*I_{buzzer} (1)

where I_{buzzer} is the AC current driven through the inductor and the constant K₁ is dependent on the buzzer construction. A good buzzer is designed to obtain a good sound level pressure with a small current. Current consumption is reduced and design of the driving circuit is made easier. A general rule is that an increased inductance value results in bigger K₂.

In order to drive the buzzer to result in a ring, the current through the inductor 210 cannot be constant. If a non constant current loop is located near the buzzer, the resulting magnetic field may be strong enough to move the magnetic material in the buzzer and therefore, to produce acoustic noise. This noise, however, is undesirable and has to be eliminated or minimized in order to prevent disruption to communication. The undesirable noise resulting from the non-constant current may be represented by the following relationship:

Noise_{buzzer}=K₂*Iₗₒₒₚ (2)

where K₂ is dependent on the coupling between the buzzer and the printed circuit board (PCB) and Iₗₒₒₚ is the non-constant current in the loop as described above. This current (i.e., Iₗₒₒₚ) is non constant due to the discontinuous transmission in the GSM system. The coupling depends on a plurality of factors such as the area of the current loop that generates the noise, area of the material that forms the inductor inside the buzzer, the distance between the current loop and the buzzer and the relative position of the buzzer and the loop. A bigger loop area causes a stronger magnetic field. The magnetic field attenuates rapidly as the buzzer is located farther from the loop which causes the field. A bigger coupling may be achieved when the loop is, as usually the case, perpendicular to the axe of the buzzer coil.

In order to minimize or eliminate Noise_{buzzer}, K₂ in equation (2) above has to be minimized. Existing solutions are focused on minimizing the current loop area and preventing the coupling between the buzzer and the PCB. In attempting to minimize the current loop area, some noise reduction may result. The noise, however, cannot be eliminated as the current loop area cannot be reduced to zero. This is due to connections for the battery, the power amplifier and other components in the power supply loop. In order to prevent coupling between the acoustic part, i.e., the buzzer, and the source of the current loop, i.e., the power amplifier, these two elements have to be spaced apart. This is not easily accomplished as the spacing required for separating the power amplifier and the acoustic parts is simply not available in cellular phones which are constantly being made smaller.

What is desired, therefore, is a method and apparatus for overcoming the limitations described above.

### SUMMARY OF THE INVENTION

Accordingly, an object of the present invention is to provide an apparatus and a method for minimizing noise.

Another object of the present invention is to provide an apparatus and a method for eliminating or canceling noise.

A further object of the present invention is to provide an apparatus and method for canceling noise.

These and other objects of the present invention are achieved by introducing a cancellation acoustic output that is equal in magnitude to a generated noise.

### BRIEF DESCRIPTION OF THE DRAWINGS

The above objects and features of the present invention will be more apparent from the following description of the preferred embodiments with reference to the accompanying drawings, wherein:

FIG. 1 illustrates a general communication system;

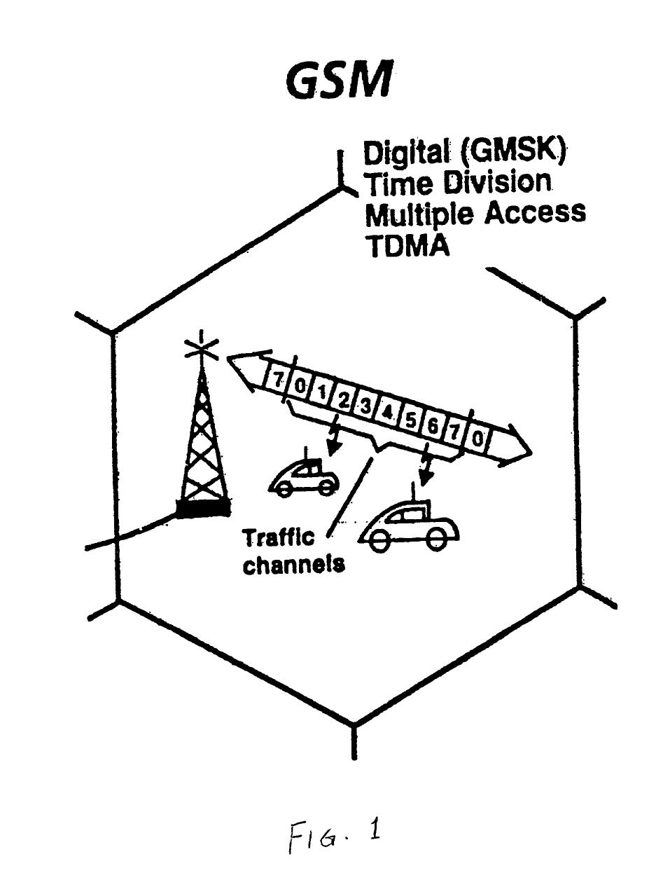

FIG. 2 illustrates a buzzer and equivalent circuit;

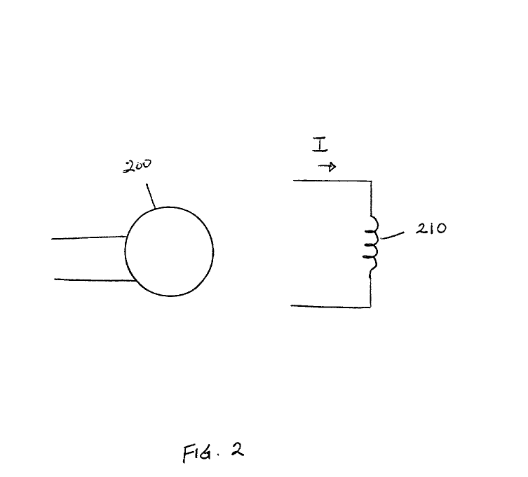

FIG. 3 illustrates a portion of a circuit board layout for a communication device;

FIG. 4 illustrates acoustic output from the buzzer of a communication device;

FIG. 5 illustrates a portion of a circuit board layout for a communication device according to exemplary embodiments of the present invention; and

FIG. 6 illustrates acoustic output from the buzzer of a communication according to exemplary embodiments of the present invention.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices and circuits are omitted so as not to obscure the description of the present invention.

The noise represented by Noise_{buzzer} (in equation 2) above may be eliminated by introducing an acoustic output (designated as “Cancellation_Signal”) that is equal in magnitude but opposite to the Noise_{buzzer}. This may be represented by:

Cancellation_Signal=−K₂*Iₗₒₒₚ (3)

Both K₂ and Iₗₒₒₚ are known. The value of K₂ is based on the buzzer selected and the PCB layout that is implemented. Iₗₒₒₚ may be determined from the power control circuitry of the communication device.

The introduction of a cancellation noise may be accomplished by one of three methods.

In the first of these methods, the source of the noise, Iₗₒₒₚ, may be measured and a corresponding cancellation signal can be created. The cancellation signal may be created utilizing analog circuitry, such as amplifiers and filters, that could be adjusted for the characteristics of the specific design of the communication device, It may also be created by utilizing analog to digital (A/D) converters, digital signal processing and digital to analog (D/A) converters. While this approach may be more flexible and easily adjustable, it is more complex to implement.

According to a second method, a noise reduction algorithm may be programmed into the RF power management ASIC (“application specific integrated chip”) which is used in communication devices such as a phone. The ASIC can produce the cancellation signal since the ASIC can determine the exact amount of current that is driven from the battery to the power amplifier (i.e., Iₗₒₒₚ). Although the redesign of the ASIC may involve a high initial cost, it can be performed in a manner such that the main parameters of the cancellation algorithm may be implemented through the use of software executing in the main controller of a communication device thereby enabling a solution to be more easily adaptable to several (phone) designs.

A third method that is more economical is through the addition of analog circuitry to the communication device. This is easier to implement as the ASIC need not be redesigned. In order to obtain noise cancellation using analog circuitry, an existing property of the power supply signal (V_{bat}) can be used.

A principal advantage of the third method is the price and ability to implement at a later stage of development or manufacture. This method needs only a few spaces in the printed circuit board (PCB) and no redesign of the existing components already on the PCB.

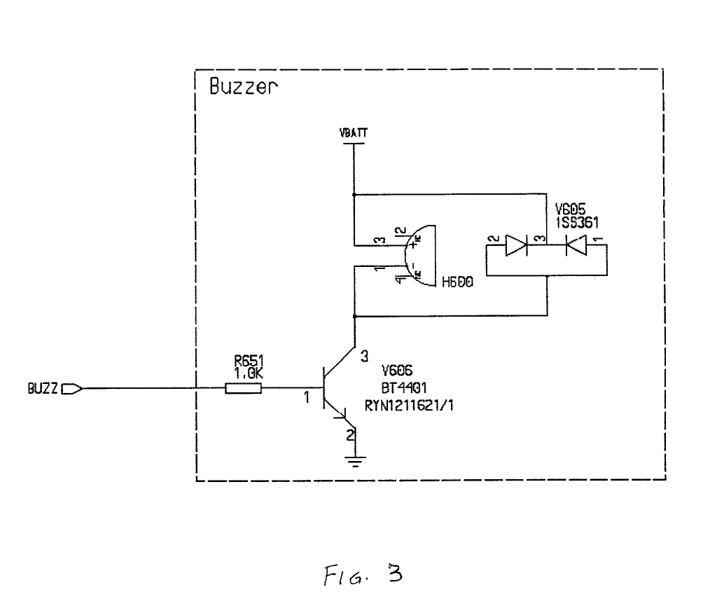

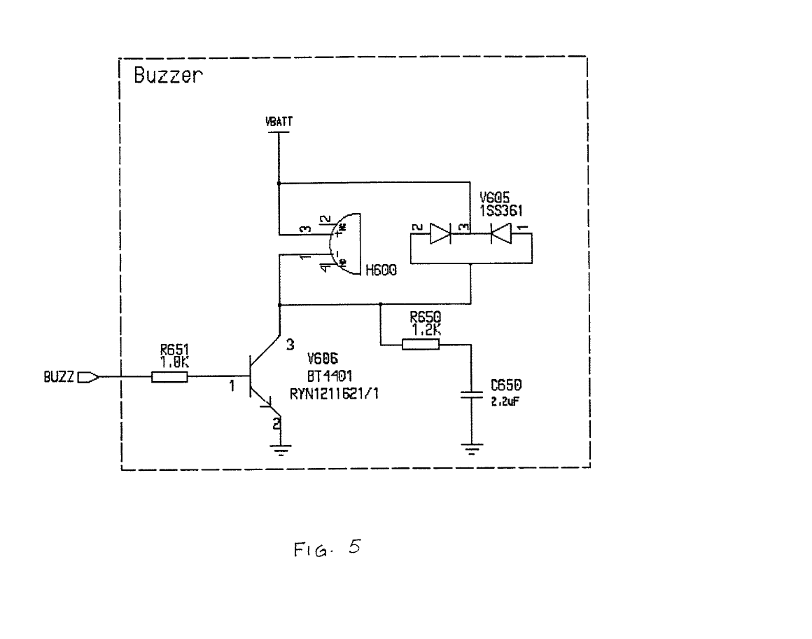

The power supply signal V_{bat}, illustrated in FIGS. 3 and 5, should, in theory, be a constant signal. However, since the battery is not an ideal voltage source due to non-zero internal resistance, a voltage drop across the internal resistance is present when there is current consumption in the power amplifiers (P.A.). A power amplifier converts DC power of the battery to a radio frequency (RF) signal having adequate power to enable the communication device to transmit a signal to a base station. The power requirements, specified or requested by the base station, for facilitating communication between the base station and a mobile communication device vary. Typically, in a GSM 900 class 4 terminal, between 3 milliwatts and 2 watts are needed and in a DCS 1800 or PCS 1900 class 1 terminal, between 1 milliwatt and 1 watt are needed. The efficiency of the PA decreases as the output power increases. Therefore, the current consumption may vary depending on the power needed either by the communication device to communicate with a base station or specified by the base station. This voltage drop may be represented by:

V_{batdrop}=Rᵢₙₜ*I (4)

where Rᵢₙₜ is the internal resistance of the battery (or, power source) and is dependent on the battery construction. I is the current taken from the battery to provide power to the device. During transmission from the communication device, the main contribution to the power consumption comes from the power amplifier and I is approximately equal to Iₗₒₒₚ where Iₗₒₒₚ is the current that flows from the battery to the power amplifier and back to the battery thus creating a current loop (as described earler) in the PCB. Therefore,

V_{batdrop}=Rᵢₙₜ*Iₗₒₒₚ (5)

FIG. 3 illustrates a conventional buzzer driving circuit and FIG. 5 illustrates a buzzer driving circuit according to exemplary embodiments of the present invention. Since V_{bat} provides the needed power to the buzzer, a path between the battery and the buzzer may be closed to allow an amount of current to flow through the buzzer. This current flow may be obtained by adding a resistor such as R₆₅₀ in FIG. 5, for example. In order to avoid dc current and therefore, eliminate power consumption in the buzzer which does not produce noise but causes power consumption, a capacitor such as C₆₅₀, for example, may be added in series with R₆₅₀ as shown in FIG. 5.

The internal resistance R_{buzzer} of the buzzer is much lower than R₆₅₀. Therefore, when R₆₅₀ is placed in series with R_{buzzer}, the additional resistance from R_{buzzer} is negligible relative to R₆₅₀. Therefore, the current through the buzzer of FIG. 5 may be represented by:

I_{buzzer}=V_{batdrop}/R₆₅₀ (6)

Using equation (5) above, this may be rewritten as

I_{buzzer}=(Iₗₒₒₚ*Rᵢₙₜ)/R₆₅₀ (7)

Referring back to equation (1), the sound produced by this current is:

Sound_{buzzer}=(K₁*Iₗₒₒₚ*Rᵢₙₜ)/R₆₅₀ (8)

With reference to equation (3), this level (i.e., Sound_{buzzer}) equals the noise needed to cancel it. This relationship may be represented by:

(K₁*Iₗₒₒₚ*Rᵢₙₜ)/R₆₅₀=−K₂*Iₗₒₒₚ (9)

Therefore,

(K₁*Rᵢₙₜ)/R₆₅₀=−K₂ (10)

The negative value for K₂ may be achieved by adjusting the manner in which the buzzer is connected. If it is improperly connected, the noise is doubled. If, on the other hand, it is properly connected, the noise is cancelled. The value of the parallel resistor R₆₅₀ may be:

R₆₅₀=(Rᵢₙₜ*K₁)/K₂ (11)

Since Rᵢₙₜ is small (approximately 50 mΩ) R₆₅₀ must be quite high (approximately 1.2 kΩ) because K₂<<K₁ (the parasitic coupling is much lower than the coupling of the driving circuit). K₂ cannot be calculated easily without a precise knowledge of the buzzer and the current distribution across the PCB. The current distribution is hard to obtain due to return currents through the ground plane and has to be recalculated each time the layout of the PCB is changed. It is more practical to obtain the value of R₆₅₀ by testing (in a laboratory, for example). A variable resistor may be mounted and the noise can be measured for different resistance values and the resistance value that results in minimizing the noise may be chosen.

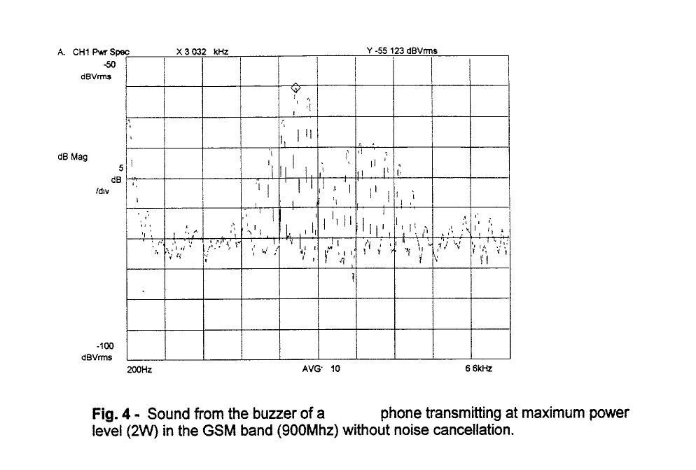

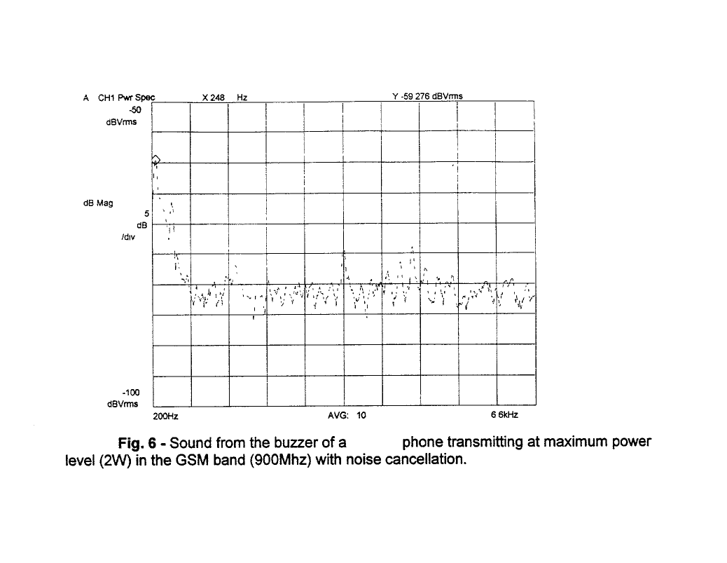

Even though Rᵢₙₜ varies between batteries, noise minimization may be achieved using apparatus and method according to exemplary embodiments of the present invention. Noise cancellation according to exemplary embodiments of the present invention is illustrated in FIG. 6. FIG. 4 illustrates noise from the buzzer of a communication device with the circuit layout of FIG. 3. As seen in FIG. 6, the noise from the buzzer is effectively cancelled out by the circuit layout of FIG. 5 which incorporates the additional resistor such as R₆₅₀.

As discussed above, a method of the present invention may also be implemented by an algorithm which generates a cancellation noise. This is a more complex approach even though it is more accurate. In the alternative, the above described approach highlights a simpler solution to the problem of noise cancellation by using the power supply from the battery, V_{bat} by adding a resistor and a capacitor.

The foregoing has described the principles, preferred embodiments and modes of operation of the present invention. However, the invention should not be construed as being limited to the particular embodiments described above. For example, the present invention can be used in loudspeaker to reduce the noise by providing a location (i.e., space) for the aforementioned capacitor and a resistor in the PCB. The above-described embodiments should be regarded as illustrative rather than restrictive, and it should be appreciated that variations may be made in those embodiments by those skilled in the art without departing from the scope of the present invention as defined by the following claims.

What is claimed is:

1. A method of reducing noise in a communication device comprising the steps of:
generating an acoustic output in a buzzer circuit; and
applying said generated output to the communication device, wherein said generated output is opposite to the noise generated in the communication device and equal in magnitude, the noise resulting from a non-constant current.

2. A method of reducing noise in a communication device comprising the step of:
generating an acoustic output in a buzzer circuit; and
applying said generated output to the communication device, wherein said generated output is opposite to the noise generated in the communication device and equal in magnitude, the noise resulting from a non-constant current and said acoustic output is generated from an analog circuit.

3. The method of claim 2, wherein said noise is generated in a buzzer circuit.

4. The method of claim 3, wherein said buzzer circuit comprises an inductive element generating a magnetic field as a result of a non-constant driving current.

5. The method of claim 4, wherein said magnetic field moves a magnetic material impacting a plate-like element to generate an audible sound.

6. The method of claim 6, wherein said analog circuit comprises a voltage source and a plurality of impedance components.

7. The method of claim 6, wherein said impedance elements comprise at least one of each of a resistor and a capacitor.

8. The method of claim 7, wherein said at least one resistor is in series with said at least one capacitor.

9. The method of claim 8, wherein said capacitor facilitates a non-constant current corresponding to the non-constant current generating the noise.

10. A method of reducing noise in a communication device comprising the steps of:
generating an acoustic output in a buzzer circuit; and
applying said generated output to the communication device, wherein said generated output is opposite to the noise generated in the communication device and equal in magnitude, the noise resulting from a non-constant current and said acoustic output is generated from an algorithm programmed into a power management application specific integrated circuit (ASIC).
